(19) United States
(12) Patent Application Publication
(10) Pub. No.: US 2016/0146073 A1
(43) Pub. Date: May 26, 2016

(54) VARIABLE VALVE GEAR

(71) Applicant: GE Jenbacher GmbH & Co OG, Jenbach (AT)

(72) Inventor: Michael HILLEBRECHT, Munich (DE)

(21) Appl. No.: 14/944,614

(22) Filed: Nov. 18, 2015

(30) Foreign Application Priority Data
Nov. 20, 2014 (AT) A 835/2014

(51) Int. Cl. F01L 13/00; F02B 75/22; F01L 1/22

(52) U.S. Cl. CPC F01L 13/0063; F01L 1/22; F02B 75/22

(57) ABSTRACT

A variable valve gear for adjusting inlet or exhaust valves of at least two cylinder banks of an internal combustion engine comprising
a camshaft carrying cams,
at least two pushrods for the transmission of a profile of the cams into a translatory movement for the actuation of inlet or exhaust valves,

wherein a rotatable adjusting member is provided between the outside contour of the cam and the pushrod, wherein the actuating times of the inlet or exhaust valves on the at least two cylinder banks can be synchronously altered by rotation of the adjusting member.

The invention concerns a variable valve gear having the features of the classifying portion of claim 1.

A variable valve gear, that is to say the possibility of adapting the control times and/or the valve lift to operating conditions, is viewed as essential technology for achieving efficiency and emission aims in internal combustion engines. There is a large number of commercially available mechanical, hydraulic or combined systems for that purpose.

An essential aim of variable valve gears is that of reducing the gas exchange work due to reduced throttle losses. A fully variable mechanical valve gear for an internal combustion engine is known for example from DE 10006018. Here, arranged between a drive means, for example a cam, a camshaft and the gas exchange valve to be actuated, is a transmission means which makes it possible to alter the lift which is predetermined by the cam contour between a minimum lift and a full lift according to the operating conditions, by way of an adjustable control element.

A common method of operating an internal combustion engine with a high degree of efficiency is the so-called “Miller cycle”. Premature closure of the inlet valves is referred to as the Miller cycle. That means that the inlet valve is closed before the piston has reached the bottom dead center point in the induction stroke. As a result the internal combustion engine is relieved of compression work, the cylinder filling remains cooler and the engine can deliver more power. The aim in that respect is to increase the degree of efficiency. The Miller cycle improves the knock behavior and the nitrogen oxide emissions by way of the internal charge cooling.

The method with extremely late inlet closure is referred to as the “Atkinson cycle”. Here too the engine has to provide less charge exchange work.

As inter alia the cold start characteristics represent a limiting factor for the position of inlet closure, a variable valve gear was already proposed for utilizing the potential of Miller and Atkinson control times. It will be noted however that fully variable valve gears, that is to say valve gears in which control times, lift curves and valve lift can be varied are very complicated and expensive.

The object of the present invention is to provide a simple system for variation of a valve opening time, which manages without complicated and expensive hydraulic or mechanical components and without camshaft adjustment.

That object is attained by a variable valve gear having the features of claim 1. Advantageous embodiments are recited in the appendant claims.

By virtue of the fact that a rotatable adjusting member is provided between the outside contour of the cam and the pushrod, wherein the actuating times of the inlet or exhaust valves on the at least two cylinder banks can be synchronously altered by rotation of the adjusting member means that a mechanical, synchronous, that is to say simultaneous, adjustment of the inlet or exhaust valves is implemented.

The variation in the actuating times is effected by the change, produced by means of rotation of the adjusting member, in the angular position of the contact points of the adjusting member on the cams. The adjusting member transmits the movement of the cam by way of pushrods to the inlet or outlet valves, in such a way that the gas exchange valves which are in opposite relationship on the at least two cylinder banks are altered synchronously in respect of their actuating times.

It can be provided that the at least two pushrods are stationarily connected to the outside contour of the adjusting member. Stationarily means that the pushrod is in engagement with the outside contour of the adjusting member and therefore the contact point also moves upon a rotation of the adjusting member with the latter.

Alternatively it can be provided that the at least two pushrods are mounted slidingly or rollingly against the outside contour of the adjusting member. In that case the pushrods are uncoupled from the adjusting member, that is to say they are not stationarily connected thereto. They can roll or slide against the outside contour of the adjusting member either by way of a roller or a sliding contact. The contact point does not have to also move with the adjusting member upon rotation thereof.

Preferably it is provided that the adjusting member is in the form of a double-arm lever, the two arms of which transmit the movement of the cam to the inlet or exhaust valves by way of the respective pushrods.

It is preferably provided that a rotation of the adjusting member provides that the cam movement is transmitted in time-altered relationship to the pushrod. Thus by rotation of the adjusting member, it is possible to cause a change in valve actuation in the direction of earlier valve opening or later valve opening.

It is preferably provided that the adjusting member has a profile for valve clearance compensation on the surface which is in engagement with the pushrod. The profile for valve clearance compensation provides that, upon rotation of the adjusting member, the contact points of the pushrod move along such curves that the valve clearance of the inlet or exhaust valves actuated by the respective pushrods remains unchanged.

Particularly preferably it is provided that the cylinder banks of the internal combustion engine are disposed in a V-arrangement. The problems of the valve clearance which changes in mutually opposite equal relationship upon adjustment of the valve opening times occurs more especially in internal combustion engines with the cylinder banks in a V-arrangement. The angle between pushrod and rocker arm is mostly close to 90°, whereby changes in the axial position of the contact point of the pushrod act directly and clearly on the valve clearance.

The adjusting member is mounted rotatably by way of an adjusting mechanism, preferably by way of an eccentric shaft, and upon rotation of the adjusting member changes the pattern of movement of the pushrods which actuate the gas exchange valves in opposite relationship on a cylinder bank by rocker arms which are possible provided. That provides that two respective gas exchange valves can be made variable in their control times with only one adjusting member. The invention is suitable in particular for internal combustion engines with the cylinders in a V-arrangement. Particularly preferably the internal combustion engine is a stationary internal combustion engine, more especially a gas engine operated on the Otto engine cycle.

Especially preferred the internal combustion engine is designed for operation on the basis of the Miller or Atkinson cycle.

The invention will now be described in greater detail by means of the Figures in which:

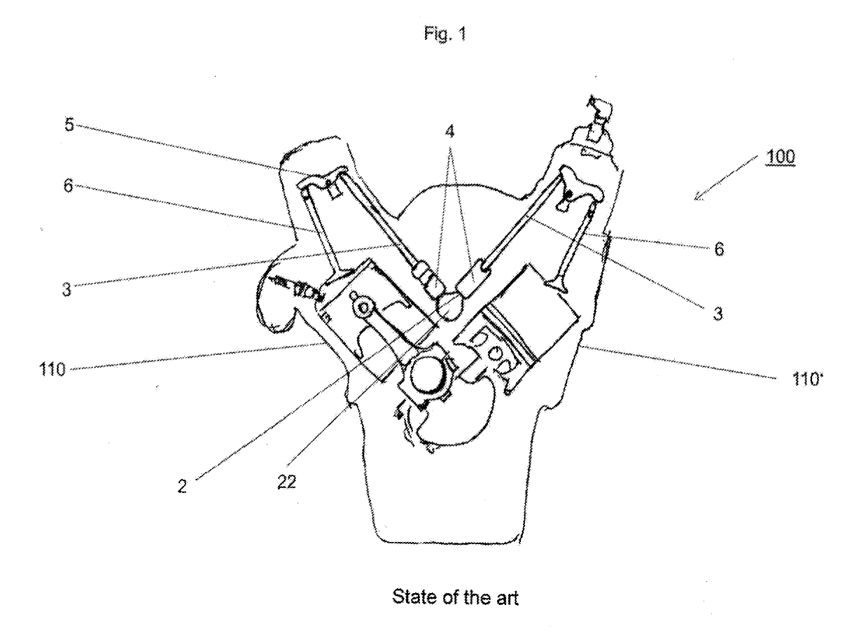

FIG. 1 shows a valve gear according to the state of the art,

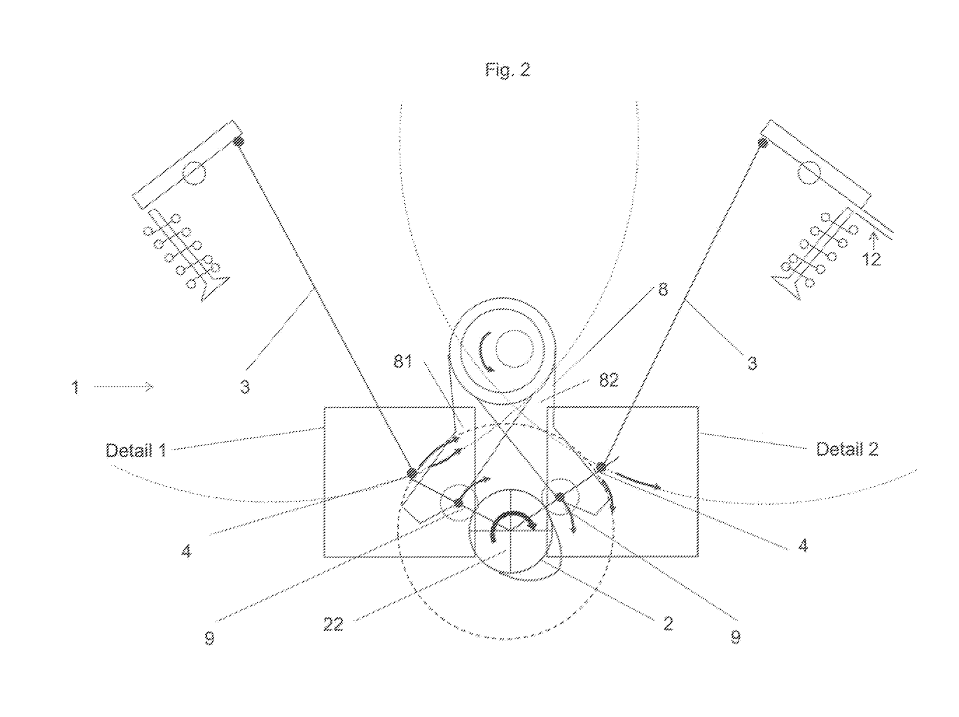

FIG. 2 shows a diagrammatic view of a variable valve gear,

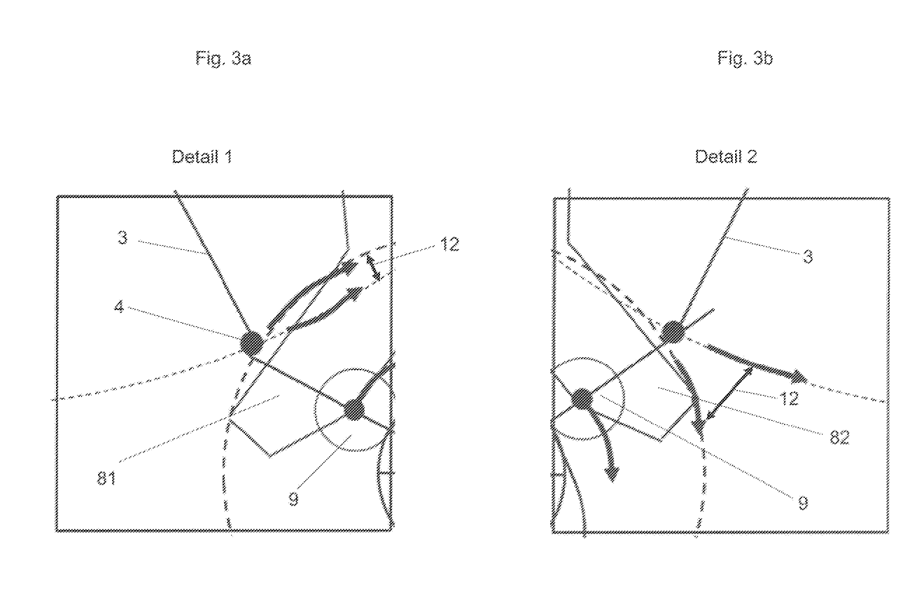

FIGS. 3a and 3b show kinematic details of the valve gear of FIG. 2,

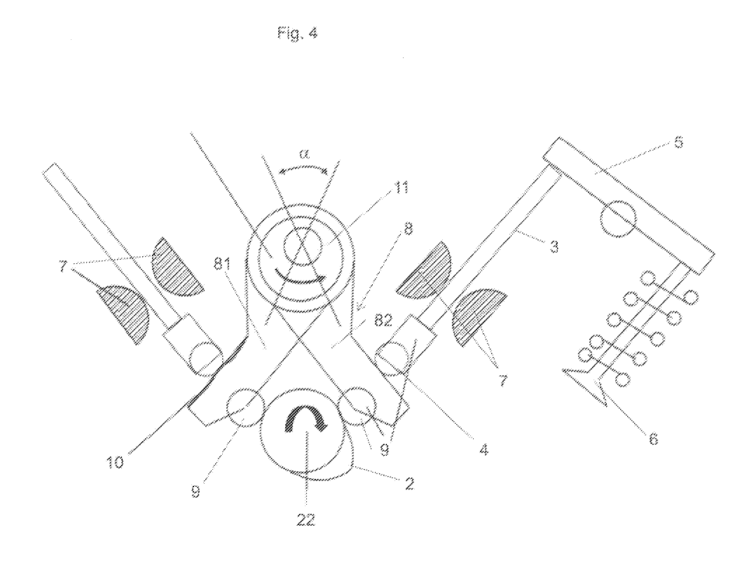

FIG. 4 shows a diagrammatic view of a variable valve gear in a second embodiment,

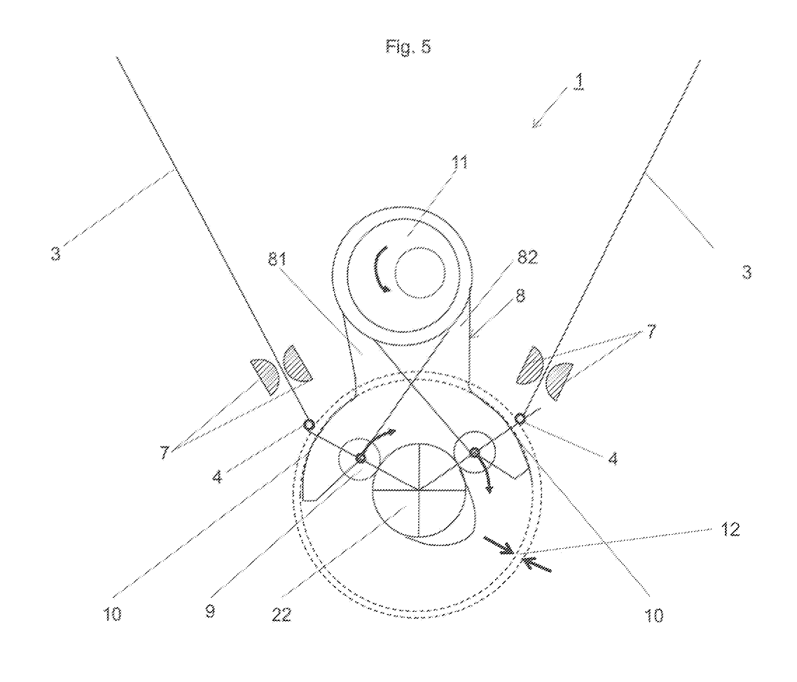

FIG. 5 shows a diagrammatic view of a variable valve gear, and

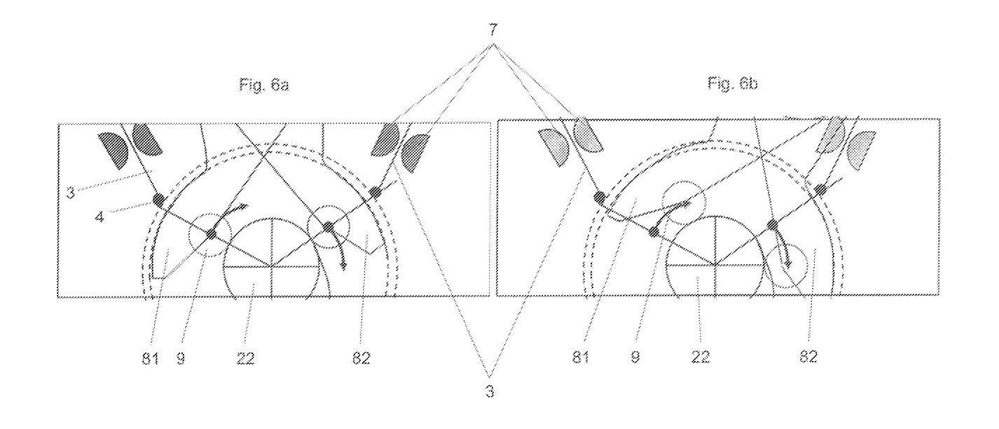

FIGS. 6a and 6b show details of FIG. 5 upon actuation of the adjusting member 8.

FIG. 1 shows the valve gear of a V-engine in accordance with the state of the art. The Figure diagrammatically shows an internal combustion engine 100 having two cylinder banks 110 and 110′ in a V-arrangement.

In this case the pushrods 3 are in contact with the cams 2 of the camshaft 22 by way of bearings 4. The profile of the cam 2, upon rotation of the camshaft 22, transmits a translatory movement to the pushrod 3 which consequently actuates the gas exchange valves 6 by way of the rocker arm 5. Because of the symmetrical structure of the internal combustion engine 100 the references for the two cylinder banks 110 and 110′ are included in part only for one side.

FIG. 2 shows a variable valve gear 1 according to a first embodiment, in a view reduced to the kinematics. The direction of rotation of the camshaft 22 is identified by an arrow and is in the clockwise direction. Arranged between the pushrod-side bearing 4 (which for example is in the form of a support roller), the pushrod 3 and the cams 2 is an adjusting member 8 in the form of a double-arm lever. The arms of the adjusting member 8 are denoted by references 81 and 82. The adjusting member 8 can be pivoted by way of an eccentrically mounted actuating shaft 11. In this embodiment the pushrods 3 are stationarily connected to the arms 81, 82. Stationarily means that the pushrods 3 are connected at their contact points to the arms 81 and 82. That can be implemented for example by way of sockets or similar means on the arms 81 and 82 respectively.

The camshaft 22 transmits a lift to the adjusting member 8 by means of cams 2 by way of the support rollers 9. The bearings 4 associated with the pushrods contact the adjusting member 8 on the side opposite to the support rollers 9.

The paths of movement of individual points are emphasized by broken-line curves. Thus it will be seen that, upon rotation of the actuating shaft 11 in the counter-clockwise direction, the support rollers 9 associated with the adjusting member move on the cam 2 in the clockwise direction. The bearing 4 at the pushrod side can be for example in the form of a support roller or a sliding contact.

In engines in a V-arrangement angles between pushrod and rocker arm that are not equal to 90° often have to be used. When employing an adjusting mechanism in accordance with the first embodiment an opening time adjustment thus leads to a reduction in the included angle on the one cylinder bank and an opening (enlargement) of the angle on the other cylinder bank. With large adjusting angles and in particular in the case of stationary pushrods that kinematically leads to a relative change in the valve clearance between the cylinder banks, that is to say while on the one side the valve clearance becomes larger it is reduced on the opposite cylinder bank. The result is an unacceptably large clearance on the one bank and, as from a given rotational angle, jamming on the other bank.

It will be clearly apparent from FIG. 2 that, by virtue of the pivotal movement of the adjusting member 8, the path of movement of the bearing 4 on the right-hand side, that is to say on the side of the lever arm 82, and the path of movement of the contour of the adjusting member 8, that is towards the bearing 4, move away from each other (box “detail 2”). Conversely the spacing of that path of movement is reduced on the left-hand side, that is to say on the side of the lever arm 81, see box “detail 2”.

It is immediately apparent that those changes in the paths of movement have an effect on the valve clearance 12. While the valve clearance 12 increases on the right-hand side (side of the lever arm 82) it is reduced on the opposite cylinder bank. The result is an unacceptably large valve clearance 12 on the one bank and jamming on the other bank.

FIGS. 3a and 3b show the details 1 and 2 from FIG. 2. It can be seen by way of example from FIG. 3a how, upon pivotal movement of the adjusting member 8, after initial opening, the valve clearance is reduced. FIG. 3b shows by way of example how the valve clearance increases in over-proportional fashion. The kinematics of the components involved therefore result in non-equalization of the valve clearance on the two cylinder banks of the V-engine.

FIG. 4 shows a variable valve gear 1 in accordance with a second embodiment. Actuation of the adjusting member 8 is effected as described for FIG. 2. The adjusting member 8 is in contact with the cam 2 of the camshaft 22 by way of the support rollers 9 associated with the adjusting member 8. The direction of rotation of the camshaft 22 is identified by an arrow and is in the clockwise direction. The bearings 4 associated with the pushrods are in contact with the adjusting member 8 on the side opposite the support rollers 9, wherein the movement surface is in the form of a valve clearance-compensating profile 10. The pushrods 3 are here guided in the crankcase by means of guides 7. The pushrods 3 roll/slide by means of bearings 4 against the outside contour of the arms 81, 82. This means that in this embodiment they are not stationarily connected to the adjusting member 8. The guides 7 allow substantially a movement of the pushrods 3 along their longitudinal axis. The guides 7 however can also be so designed that as clearance they also allow a movement normal thereto. To illustrate that additionally allowed pivotal movement the guides 7 are shown as being of a spherical or crowned configuration in FIG. 4. The angular position of the contact point of the adjusting member 8 on the cam 2 is variable by rotation of the adjusting member 8. The term angular position is used to mean the camshaft angle. It is usual to specify control times in degrees of camshaft angle (degree crank angle, ° CA). If for example the adjusting member 8 is pivoted towards the right through an angle a that leads to a displacement of the valve lift curves in the direction of late closure for the angular position of the contact points of the adjusting member 8, in this embodiment provided by way of the support rollers 9, is displaced in the clockwise direction. In that way the contact points are correspondingly later engaged by the cam. Here the negative effect described with reference to FIGS. 2, 3a and 3b, of an asymmetrically changing valve clearance upon actuation of the adjusting member, is avoided by the valve clearance-compensating profile 10. The profile 10 is geometrically of such a configuration that it compensates for the change in the valve clearance, caused by the kinematics involved. As a result the valve clearance for both cylinder banks remains constant over the adjusting angle of the adjusting member 8. The precise configuration of the profile naturally depends on the geometrical conditions of the respective valve gear and can be calculated therefrom by the man skilled in the art. It will be seen in the embodiment of FIG. 4 with decoupled pushrods that, in comparison with the embodiment of FIG. 2 with stationary pushrods, there is a greater degree of freedom in regard to the attainable adjustment angles.

FIG. 5 shows a diagrammatic view of a variable valve gear 1 in a reduced kinematic representation. The pushrods 3 are guided in guides 7 which allow clearance as described in relation to FIG. 4. The inner broken-line circle is the circumference of the outside contour of the arms 81, 82. The second broken-line circle spaced therefrom shows the valve clearance 12 which is constant over the rotation of the adjusting member 8.

FIGS. 6a and 6b show details from FIG. 5 upon actuation of the adjusting member 8.

It is thus possible with the proposed solution with decoupled pushrods to adjust the control times within large angular ranges (for example up to 12° crankshaft angle) and at the same time to keep the valve clearance constant, by the provision of a valve clearance-compensating profile.

The pushrod ends can be both in the form of rollers and also sliding components (for example of ceramic) so that this gives a simplification in the overall system.

### LIST OF REFERENCES USED

1 variable valve gear
2 cam
22 camshaft
3 pushrod
4 bearing pushrod side
5 rocker arm
6 gas exchange valve
7 guide
8 adjusting member
81, 82 arms of the adjusting member
9 support roller cam side
10 profile
11 actuating shaft
12 valve clearance
100 internal combustion engine
110, 110′ cylinder banks

1. A variable valve gear for adjusting inlet or exhaust valves of at least two cylinder banks of an internal combustion engine comprising
a camshaft carrying cams,
at least two pushrods for the transmission of a profile of the cams into a translatory movement for the actuation of inlet or exhaust valves,
wherein a rotatable adjusting member is provided between the outside contour of the cam and the pushrod, wherein the actuating times of the inlet or exhaust valves on the at least two cylinder banks can be synchronously altered by rotation of the adjusting member.

2. A variable valve gear as set forth in claim 1, wherein the at least two pushrods are stationarily connected to the outside contour of the adjusting member.

3. A variable valve gear as set forth in claim 1, wherein the at least two pushrods are mounted slidingly or rollingly against the outside contour of the adjusting member.

4. A variable valve gear as set forth in at claim 1, wherein the adjusting member is in the form of a double-arm lever, the two arms of which transmit the movement of the cam to the inlet or exhaust valves by way of the respective pushrods.

5. A variable valve gear as set forth in claim 1, wherein a rotation of the adjusting member provides that the cam movement is transmitted in time-altered relationship to the pushrod.

6. A variable valve gear as set forth in claim 1, wherein the adjusting member has a profile for valve clearance compensation on the surface which is in engagement with the pushrod.

7. A variable valve gear as set forth in claim 1, wherein the cylinder banks of the internal combustion engine are disposed in a V-arrangement.
